(19) United States
(12) Patent Application Publication
(10) Pub. No.: US 2017/0070976 A1
(43) Pub. Date: Mar. 9, 2017

(54) PORTABLE TERMINAL AND CONTROL METHOD FOR PORTABLE TERMINAL

(71) Applicant: SHARP KABUSHIKI KAISHA, Sakai City, Osaka (JP)

(72) Inventor: Atsushi SHIRAKAWA, Sakai City (JP)

(21) Appl. No.: 15/123,004

(22) PCT Filed: Jan. 16, 2015
(86) PCT No.: PCT/JP2015/051116

§ 371 Date: Sep. 1, 2016

(30) Foreign Application Priority Data
Mar. 6, 2014 (JP) 2014-044324

(51) Int. Cl. H04W 72/02; H04W 48/20; H04W 72/10

(52) U.S. Cl. CPC H04W 72/02; H04W 72/10; H04W 48/20; H04W 88/085

(57) ABSTRACT

In a case where a 2.4 GHz band access point (20) and a 5 GHz band access point (22) are attached to the same wireless base station (2), the portable terminal (1) sets a higher priority to the access point (22). Consequently, the portable terminal (1) connects preferentially to the access point (22) through which higher throughput is obtained.

### TECHNICAL FIELD

The present invention relates to (i) a portable terminal having the capability of wireless communications and (ii) a method for controlling the portable terminal.

### BACKGROUND ART

In recent years, sophisticated portable terminals such as smart phones have been rapidly spread, and high-volume data communications through the use of the portable terminals have been actively made every day. As a result, communication carriers which offer data communication services through portable terminals can be faced with situations in which troubles such as a communication failure or a connection failure occur due to data traffic overload in cellular communication networks. As one strategy to solve such a problem, data offloading to public wireless LAN services is known. This strategy allows for data communications performed through public wireless LANs rather than through cellular communication networks, thereby enabling the reduction of communication loads on the cellular communication networks.

Currently, frequency bands used in the public wireless LANs are mainly a 2.4 GHz band and a 5 GHz band. The 2.4 GHz band, which is the so-called IMS frequency band, is widely used by many devices and systems (e.g., Bluetooth (registered trademark), a cordless telephone, a microwave oven, etc.), and the bandwidth of the 2.4 GHz band is inherently narrow. As such, only about three channels are used as wireless communication channels available in the 2.4 GHz band without causing interferences with each other. Thus, the current situation is that even the 2.4 GHz band used in the public wireless LANs is congested.

Meanwhile, channels available in the 5 GHz band are about 20 channels, which are larger than the number of channels available in the 2.4 GHz band, and a relatively large number of channels are vacant in the 5 GHz band. Under such circumstances, data offloading to the public wireless LAN used in the 5 GHz band has been required.

As a general state of the art, a portable terminal which prioritizes connection to the 5 GHz band is known. Such a portable terminal, in a situation where both a 2.4 GHz band access point and a 5 GHz band access point are present as candidates for connection, connects to the 5 GHz band access point as long as a signal strength differential between them falls within a certain value (e.g., 5 dB), even though a lower signal strength is provided in the 5 GHz band.

Meanwhile, Patent Literature 1 discloses a wireless communication device which (i) stores connection information, in which information on other party's device type is associated with information on a wireless network used during wireless communications with the other party, and (ii) preferentially displays, of all wireless networks present around the wireless communication device, a wireless network that is associated with a device type selected in the connection information.

### CITATION LIST

### Patent Literature

### [Patent Literature 1]

Japanese Patent Application Publication Tokukai No. 2013-162322 (Publication date: Aug. 19, 2013)

### SUMMARY OF INVENTION

### Technical Problem

Unfortunately, the conventional techniques described above cannot achieve desired connections to the 5 GHz band every time.

Usually, a portable terminal calculates a signal strength value (RSSI) with use of a frame of a radio signal received from an access point. Specifically, the portable terminal transmits a scan request (ProbeRequst frame) to the access point at the beginning of wireless communication connection. In response to the scan request, the access point transmits a scan response (ProbeResponse frame) to the portable terminal. The portable terminal calculates RSSI with use of a received one frame only and uses the calculated RSSI as information on which to determine a connection destination.

Unfortunately, RSSI inherently tends to vary depending on the environment of wireless communications. Further, since RSSI is often calculated by an analog circuit in the portable terminal, an error is likely to occur during the calculation of RSSI. Moreover, RSSI in the 5 GHz band is hard to be stable from the viewpoint of characteristics of a radio signal.

Straightness and attenuation of radio signals in the 5 GHz band are higher than those of radio signals in the 2.4 GHz band. Therefore, even just a passage of a person in between the 5 GHz band access point and the portable terminal makes RSSI smaller than its actual value. Such a problem can be addressed by the portable terminal in such a way that it calculates RSSIs a plurality of times based on scan responses obtained a plurality of times, and then averaged the RSSIs thus calculated. This approach, however, requires reception of a plurality of scan responses at certain time intervals, and thus raises another problem that a time required for the completion of connection is increased.

As described above, the portable terminal of the conventional technique may erroneously calculate the RSSI in the 5 GHz band to be smaller than its actual value. Accordingly, the portable terminal of the conventional technique may erroneously connect to the 2.4 GHz band access point, which leads to poorer performance, even in a situation where conditions for connection to the 5 GHz band access point, through which higher throughput is obtained are met.

The present invention has been attained to solve the above problem. It is an object of the present invention to provide (i) a portable terminal that connects preferentially to an access point through which higher throughput is obtained and (ii) a method for controlling the portable terminal.

### Solution to Problem

In order to solve the above problem, a portable terminal in accordance with the present invention includes: a determining section that determines whether a plurality of different access points capable of wireless communications with the portable terminal are attached to the same wireless base station; a setting section that sets, to a first access point that is one of the plurality of access points having been determined to be attached to the same wireless base station, a priority higher than a priority of the other access point, the first access point providing (i) the largest number of available channels and/or (ii) the largest amount of channel bandwidth among all the plurality of access points having been determined to be attached to the same wireless base station; and a connecting section that attempts wireless communication connections to the access points in descending order of the priorities set by the setting section.

### Advantageous Effects of Invention

One aspect of the present invention yields the effect of allowing the portable terminal to connect preferentially to an access point through which higher throughput is obtained.

### BRIEF DESCRIPTION OF DRAWINGS

FIG. 1 is a block diagram illustrating main components of a portable terminal in accordance with a first embodiment of the present invention.

FIG. 2 is a diagram illustrating the portable terminal in accordance with the first embodiment of the present invention and a wireless base station that provides the portable terminal with a public wireless LAN.

FIG. 3 is a flowchart illustrating a flow of a process in which the portable terminal in accordance with the first embodiment of the present invention performs connection to an access point.

FIG. 4 is a diagram illustrating an example of pieces of access point information in accordance with the first embodiment of the present invention.

FIG. 5 is a diagram illustrating an example of a mask for use in comparison between BSSIDs in the first embodiment of the present invention.

FIG. 6 is a diagram illustrating an example of a given threshold RSSI value that is preset by the portable terminal in accordance with the first embodiment of the present invention.

FIG. 7 is a diagram illustrating a portable terminal in accordance with a second embodiment of the present invention and two different wireless base stations each of which provides the portable terminal with a public wireless LAN.

FIG. 8 is a diagram illustrating an example of pieces of access point information in accordance with the second embodiment of the present invention.

FIG. 9 is a diagram illustrating an example of bandwidth modes which can be set with respect to a 5 GHz band access point in accordance with a third embodiment of the present invention.

FIG. 10 is a flowchart illustrating a flow of a process in which a change determining section in accordance with the third embodiment of the present invention determines whether to permit a priority change.

FIG. 11 is a diagram illustrating an example of given threshold values that are preset corresponding one-to-one to individual bandwidth modes in a portable terminal in accordance with the third embodiment of the present invention.

FIG. 12 is a diagram illustrating an example of pieces of access point information in accordance with a fourth embodiment of the present invention.

### DESCRIPTION OF EMBODIMENTS

### Embodiment 1

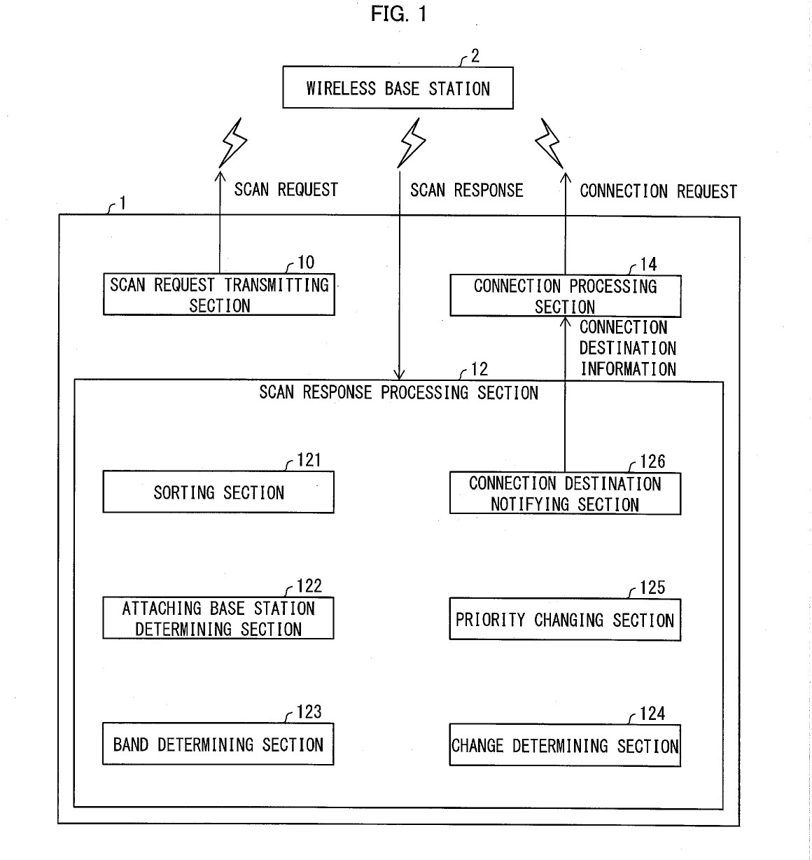

The following description will discuss a first embodiment in accordance with the present invention with reference to FIGS. 1 to 6.

(Overview of Portable Terminal 1)

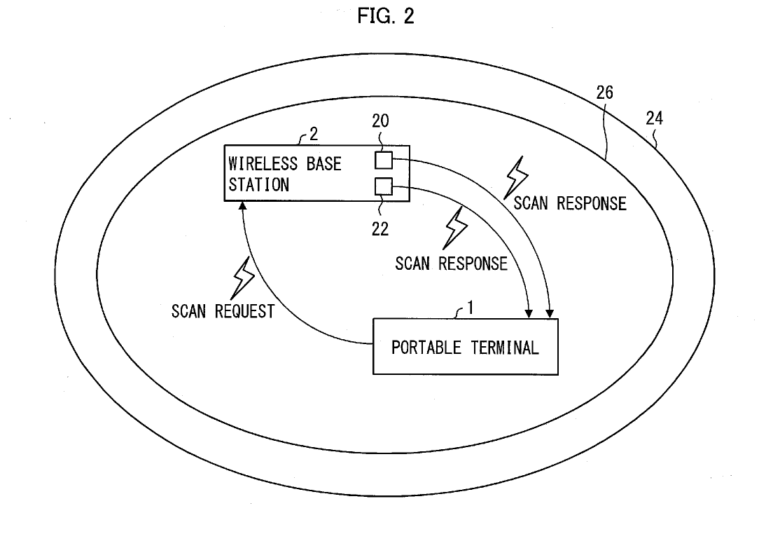

FIG. 2 is a diagram illustrating a portable terminal 1 in accordance with the first embodiment of the present invention and a wireless base station 2 that provides the portable terminal 1 with a public wireless LAN. In the first embodiment, the portable terminal 1 is a wireless communication terminal capable of being carried by a user and having a wireless communication function. The portable terminal 1 is implemented as, for example, a portable telephone, a smart phone, or a tablet terminal. Note that the portable terminal 1 is also implemented as a mobile router that relays wireless communications by another wireless communication terminal.

The wireless base station 2 is a hub that relays connection of the portable terminal 1 to the Internet through wireless communications. In the first embodiment, the wireless base station 2 provides the portable terminal 1 with two types of public wireless LANs on which radio signals are transmitted in different frequency bands. The portable terminal 1 can make access to the Internet via the wireless base station 2 by making access to any one of the public wireless LANs.

As illustrated in FIG. 2, the wireless base station 2 includes two different access points 20 and 22. In other words, both the access points 20 and 22 are attached to the wireless base station 2. The access point 20 (other access point) supports 2.4 Hz band wireless communications. Meanwhile, the access point 22 (first access point) supports 5 GHz band wireless communications.

The number of wireless communication channels available for the 5 GHz band access point 22 is larger than that of wireless communication channels available for the 2.4 GHz band access point 20. For example, about 20 channels are available for the 5 GHz band access point 22, while about 3 channels are available for the 2.4 GHz band access point 20. However, the present invention is not limited to these numbers of wireless communication channels.

A channel bandwidth provided for the 5 GHz band access point 22 is larger than a channel bandwidth provided for the 2.4 GHz band access point 20. For example, the channel bandwidth provided for the 5 GHz band access point 22 is 80 MHz, while the channel bandwidth provided for the 2.4 GHz band access point 20 is 20 MHz. However, the present invention is not limited to these channel bandwidths.

As illustrated in FIG. 2, the wireless base station 2 covers two types of wireless communication cells 24 and 26 in which different frequency bands are used. The cell 24 corresponds to a 2.4 GHz band, while the cell 26 corresponds to a 5 GHz band. Due to their corresponding radio frequency characteristics, the cell 24 is larger than the cell 26. As such, in an area within the cell 26, the portable terminal 1 can connect to either the 2.4 GHz band access point 20 or the 5 GHz band access point 22. Meanwhile, in an area falling outside the cell 26 and within the cell 24, the portable terminal 1 can connect to the 2.4 GHz band access point 20, but cannot connect to the 5 GHz band access point 22.

The portable terminal 1 can access the Internet via the access point 20 or 22. Communications between the portable terminal 1 and the access point 20 are wireless communications in the 2.4 GHz band. Meanwhile, communications between the portable terminal 1 and the access point 22 are wireless communications in the 5 GHz band.

The portable terminal 1 transmits a given scan request, which is a radio signal, for connecting to any of the public wireless LANs. Upon receipt of the scan request, the wireless base station 2 transmits a scan response, which is a response to the scan request, to the portable terminal 1. In the first embodiment, the access points 20 and 22 transmit their respective scan responses to the portable terminal 1. A scan response from the access point 20 includes various kinds of information on the access point 20. Meanwhile, a scan response from the access point 22 includes various kinds of information on the access point 22. The information on the access point 20 and the information on the access point 22 will be discussed later in detail.

The portable terminal 1 determines an intended access point to connect based on the received scan responses, and then requests that access point for a wireless communication connection. The access point having received that request establishes a wireless communication connection with the portable terminal 1. In doing so, the access point performs a given authentication process to authenticate the portable terminal 1. After the establishment of a wireless communication has been made, the portable terminal 1 can access the Internet via the access point 20 or 22.

(Configuration of Portable Terminal 1)

FIG. 1 is a block diagram illustrating main components of the portable terminal 1 in accordance with the first embodiment of the present invention. As illustrated in FIG. 1, the portable terminal 1 includes a scan request transmitting section 10, a scan response processing section 12 (determining section, setting section), and a connection processing section 14 (connecting section). The scan response processing section 12 includes a sorting section 121, an attaching base station determining section 122 (determining section), a band determining section 123, a change determining section 124 (determining section), a priority changing section 125 (setting section), and a connection destination notifying section 126. Functions and roles of these components will be discussed later.

(Flow of Process)

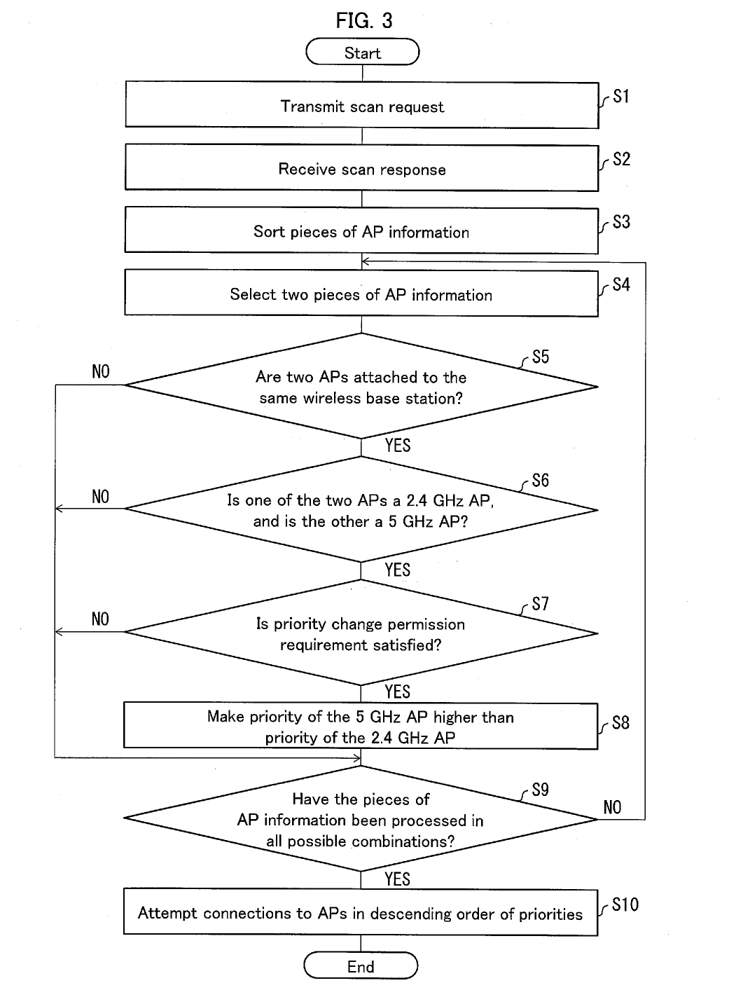

The following description will discuss a flow of a process in which the portable terminal 1 performs wireless communication connection to the access point 20 or 22, with reference to FIGS. 3 to 6. In FIGS. 3 to 6, the term “AP” means an access point.

FIG. 3 is a flowchart illustrating a flow of a process in which the portable terminal 1 in accordance with the first embodiment of the present invention performs wireless communication connection to the access point 20 or 22. First, as illustrated in FIG. 3, the scan request transmitting section 10 transmits a given scan request for connecting to a public wireless LAN (step S1). When the wireless base station 2 receives the scan request, the access points 20 and 22 within the wireless base station 2 transmit their respective scan responses. These scan responses are received by the scan response processing section 12 (step S2).

The scan response from the access point 20 or 22 includes a designation of the access point 20 or 22, Basic Service Set Identifier (BSSID), and a frequency band value. The scan response from the access point 20 includes the designation of the access point 20 (AP20), BSSID (11:22:33:44:55:66), and the frequency band value (2.4 GHz). Meanwhile, the scan response from the access point 22 includes the designation of the access point 22 (AP22), BSSID (11:22:33:44:55:67), and the frequency band value (5 GHz). By extracting these pieces of information from each of the received scan responses and then associating these pieces of information with one another for each of the scan responses, the scan response processing section 12 generates a given piece of access point information for each of the access points.

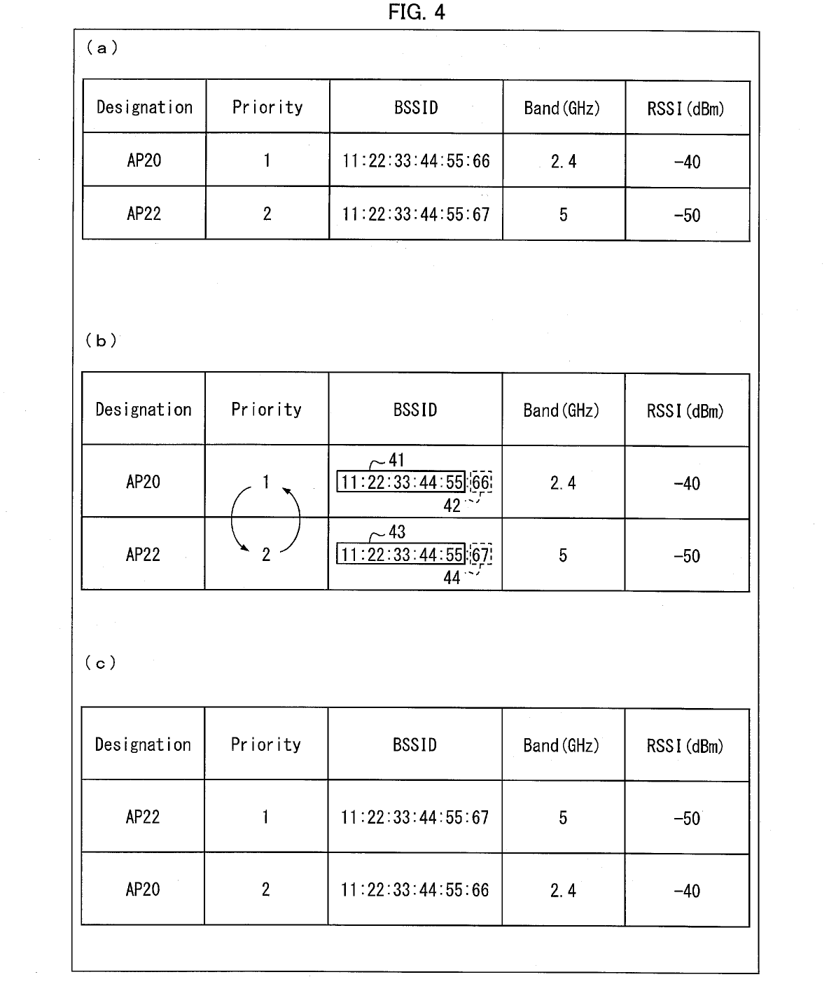

For each of the received scan responses, the scan response processing section 12 calculates a signal strength value (RSSI) of each of the scan responses and then associates the signal strength value with the corresponding access point information. In the first embodiment, a signal strength value of RSSI of the access point 20 is −40 dBm. Meanwhile, a signal strength value of RSSI of the access point 22 is −50 dBm. Example pieces of the access point information generated in such a manner are illustrated in FIG. 4. FIG. 4 is a diagram illustrating an example of pieces of access point information in accordance with the first embodiment of the present invention.

The sorting section 121 sorts the plurality of pieces of access point information thus generated, in order of decreasing RSSI (step S3). In doing so, the sorting section 121 sets a given priority to each of the access points according to the RSSIs. As illustrated in (a) of FIG. 4, the sorting section 121 sets Priority 1, which indicates the highest priority, to the access point 20 with the highest RSSI (−40 dBm). Meanwhile, the sorting section 121 sets Priority 2, which indicates the next highest priority, to the access point 20 with the next highest RSSI (−50 dBm). The sorting section 121 associates the set priorities with the corresponding pieces of access point information. This completes the sorting of the pieces of access point information. At this stage, the access point 20 capable of operating in the 2.4 GHz band has the highest priority.

(Determination of Attaching Wireless Base Station)

After the pieces of access point information have been sorted, the attaching base station determining section 122 selects a newly combined two pieces of access point information from all of the generated pieces of access point information (step S4). Subsequently, the attaching base station determining section 122 determines, based on the two pieces of access point information thus selected, whether the two access points corresponding to these two pieces of access point information are attached to the same wireless base station (step S5). In the first embodiment, since only two pieces of access point information are generated, the attaching base station determining section 122 determines whether the access points 20 and 22 are attached to the same wireless base station, i.e., the wireless base station 2.

In the first embodiment, the attaching base station determining section 122 determines the attaching wireless base station with use of the BSSID, which is contained in each of the pieces of access point information. The BSSID is (i) a MAC address assigned to each access point and is (ii) individual identification information composed of a total of 6 bytes (48 bits). In a case where two BSSIDs are consecutive numbers or where values of a predetermined number of bits in a certain area of one of the two BSSIDs are identical to those of the predetermined number of bits in the corresponding area of the other BSSID, the attaching base station determining section 122 determines that the two BSSIDs are similar. Further, in a case where the attaching base station determining section 122 determines that these two BSSIDs are similar, the attaching base station determining section 122 determines that the two access points are attached to one and the same wireless base station.

As illustrated in (b) of FIG. 4, a value of a high-order 5-byte area 41 of a BSSID of the access point 20 is equal to that of a high-order 5-byte area of a BSSID of the access point 22. Meanwhile, a value (66) in a low-order byte area 42 of the BSSID of the access point 20 differs from a value (67) in a low-order 1-byte area of the BSSID of the access point 20 and 22. However, the values of the two BSSIDs are identical except for the 1-byte value. In a case where such conditions are satisfied, the attaching base station determining section 122 determines that the BSSID of the access point 20 is similar to the BSSID of the access point 22.

(Determination Performed with Use of Mask)

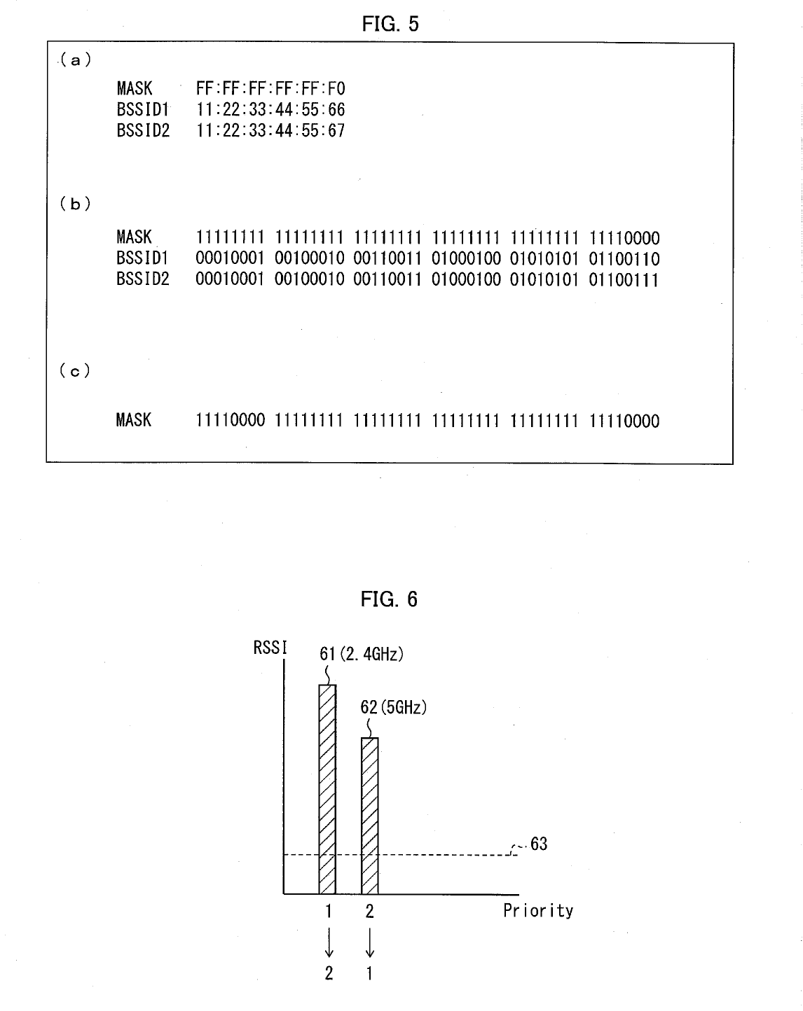

The attaching base station determining section 122 determines whether two BSSIDs are similar, with use of a given mask (MASK). Details of such a determination will be discussed with reference to FIG. 5. FIG. 5 is a diagram illustrating an example of a mask for use in comparison between BSSIDs in the first embodiment of the present invention. The mask is information composed of a total of 6 bytes (48 bits), as in the case of the BSSID. In an example illustrated in (a) of FIG. 5, a value of the mask is FF:FF:FF:FF:FF:F0. Note that, in FIG. 5, BSSID1 is a BSSID of the access point 20, while BSSID2 is a BSSID of the access point 22.

In (a) of FIG. 5, the mask, BSSID1, and BSSID2 are each represented in hexadecimal numbers. In (b) of FIG. 5, the mask, BSSID1, and BSSID2 are each represented in binary numbers (i.e., in bits). In the mask, consecutive values of high-order 44 bits are all “1”, while consecutive values of low-order 4 bits are all “0”. With use of such a mask, the attaching base station determining section 122 determines whether the following logical expression (1) holds.

NOT(BSSID1 XOR BSSID2) AND MASK=MASK Expression (1)

In a case where the logical expression (1) holds, the attaching base station determining section 122 determines that the two BSSIDs are similar. On the other hand, in a case where the logical expression (1) does not hold, the attaching base station determining section 122 determines that the two BSSIDs are dissimilar. The following description will discuss main points of the mask-based BSSID similarity determination. The attaching base station determining section 122 determines that BSSID1 and BSSID2 are similar to each other in a case where bit values of BSSID1 at positions corresponding to the bits whose values are all “1” in the mask are completely identical to bit values of BSSID2 at positions corresponding to the bits whose values are all “1” in the mask. The mask, BSSID1, and BSSID2 illustrated in (b) of FIG. 5 satisfy such a condition.

The mask used by the attaching base station determining section 122 is not limited to the mask illustrated in (b) of FIG. 5. For example, a mask as illustrated in (c) of FIG. 5 can be used alternatively. The mask illustrated in (c) of FIG. 5 is identical to the mask illustrated in (b) of FIG. 5, except that values of high-order 5th to 8th bits are “0”. Even with use of this mask, the result of the logical expression (1) is not different. Specifically, bit values of BSSID1 at positions corresponding to the bits whose values are all “1” (the 1st to 4th bits and the 9th to 44th bits) in the mask illustrated in (c) of FIG. 5 are completely identical to bit values of BSSID2 at positions corresponding to the bits whose values are all “1” in the mask.

(Determination of Frequency Band)

If the result of the determination performed in step S5 is “true” (YES), the band determining section 123 uses the two pieces of access point information to determine whether one of the two access points is a 2.4 GHz band access point, while the other access point is a 5 GHz band access point (step S6). The band determining section 123 performs the determination in step S6, with use of respective frequency band values contained in the two pieces of access point information. In a case where the pieces of access point information illustrated in (a) of FIG. 4 are used, the band determining section 123 determines that a frequency band of the access point 20 is 2.4 GHz band, while a frequency band of the access point 22 is 5 GHz band. In that case, the result of the determination performed in step S6 is true.

(Determination Concerning Priority Change Permission Requirement)

If the result of the determination performed in step S6 is “true” (YES), the change determining section 124 uses the two pieces of access point information to determine whether the access points 20 and 22 satisfy a specified priority change permission requirement (step S7). In the first embodiment, the priority change permission requirement is a requirement such that RSSI of the 5 GHz band access point 22 exceeds a given threshold value that is preset by the portable terminal 1. An example of the threshold value is shown in FIG. 6.

FIG. 6 is a diagram illustrating an example of a given threshold RSSI value that is preset by the portable terminal 1 in accordance with the first embodiment of the present invention. In the example illustrated in FIG. 6, “61” represents RSSI calculated based on the scan response from the access point 20 (2.4 GHz band). Further, “62” represents RSSI calculated based on the scan response from the access point 22 (5 GHz band). Still further, “63” represents the given threshold value that is predetermined by the portable terminal 1. In the example illustrated in FIG. 6, the RSSI 62 is higher than the threshold value 63. As such, the change determining section 124 determines that the access points 20 and 22 satisfy the priority change permission requirement.

(Priority Change)

If the result of the determination performed in step S7 is “true” (YES), the priority changing section 125 sets, to the 5 GHz band access point 22, a priority that is higher than a priority of the 2.4 GHz band access point 20 (step S8). Specifically, as illustrated in (b) of FIG. 4, the priority changing section 125 inverts the priority of the access point 20 and the priority of the access point 22. Accordingly, the pieces of access point information are changed as illustrated in (c) of FIG. 4. With the priority change, the priority of the access point 20 is decreased from “1” to “2”, whereas the priority of the access point 22 is increased from “2” to “1”. That is, a priority higher than the priority of the 2.4 GHz band access point 20 is set to the 5 GHz band access point 22.

After the priority change has been made, the scan response processing section 12 determines whether all of the pieces of access point information have been processed in twos and in all possible combinations (step S9). If the result of the determination performed in step S9 is “false” (NO), the procedure shown in FIG. 3 returns to step S4. Accordingly, the attaching base station determining section 122 selects another new combination of two pieces of access point information that have not yet been compared. In this manner, the scan response processing section 12 repeats the processes in steps S4 to S9 until all of the pieces of access point information are processed in all possible combinations.

(Connection to Access Point)

On the other hand, if the result of the determination performed in step S9 is “true” (YES), the portable terminal 1 attempts connections to the access points in descending order of priorities (step S10). Specifically, the connection destination notifying section 126, first, outputs, to the connection processing section 14, connection destination information for notifying which of the plurality of pieces of access point information contains the highest priority. The connection processing section 14 transmits a connection request to the access point which is specified by the received connection destination information. In the first embodiment, as illustrated in (c) of FIG. 4, the 5 GHz band access point 22 has the highest priority after the priority change. As such, the connection processing section 14, first, attempts connection to the access point 22 by transmitting a connection request to the access point 22. If the access point 22 normally receives the connection request, necessary communications are done between the access point 22 and the portable terminal 1 to establish 5 GHz band wireless communication connection between the access point 22 and the portable terminal 1. As a result, the portable terminal 1 can access the Internet via the access point 22, which supports 5 GHz band wireless communications.

(Advantages of the First Embodiment)

As described above, in the case where the portable terminal 1 has determined that the 2.4 GHz band access point 20 and the 5 GHz band access point 22 are attached to the same wireless base station, i.e., the wireless base station 2, the portable terminal 1 inverts the priority of the access point 20 and the priority of the access point 22. Specifically, a priority higher than the priority of the access point 20 is set to the access point 22, which provides (i) a larger number of channels and/or (ii) a larger amount of channel bandwidth than those of the access point 20. Accordingly, the portable terminal 1 connects preferentially to the 5 GHz band access point 22, which resides in the same wireless base station, i.e., the wireless base station 2. This achieves the completion of connection to the 5 GHz band access point 22, which can experience less congestion than the 2.4 GHz band access point does and can be expected to achieve higher throughput. This allows the portable terminal 1 to perform faster and more stable wireless communications.

Further, the portable terminal 1 determines whether the access points 20 and 22 are attached to the same wireless base station, i.e. the wireless base station 2, with use of the respective BSSIDs of the access points 20 and 22, which BSSIDs are contained in the individual pieces of access point information. This makes it possible to enhance a speed of the determination and reliability of the determination.

Still further, in a case where the RSSI of the access point 22 is not more than a given threshold value, the portable terminal 1 does not change the priority of the access point 22. This makes it possible to prevent the portable terminal 1 from connecting to the access point 22 in a situation where a failure to perform normal wireless communications can occur because the RSSI of the access point 22 is too low. This assures fast and stable wireless communications between the portable terminal 1 and the access point 22.

(Modifications)

In the first embodiment, two access points are attached to the wireless base station 2. However, the number of access points attached to the wireless base station 2 is not limited. In a case where three or more access points are attached to the same wireless base station, i.e. the wireless base station 2, the portable terminal 1 also changes the priorities of the access points in the same manner. Specifically, the portable terminal 1 sets, to a certain access point that is one of a plurality of access points that have been determined to be attached to the same wireless base station, i.e., the wireless base station 2, a priority higher than a priority of the other access points, wherein the certain access point provides (i) the largest number of available channels and/or (ii) the largest channel bandwidth among all the plurality of access points that have been determined to be attached to the same wireless base station, i.e., the wireless base station 2.

For example, assume that a first access point, which operates in the 2.4 GHz band, a second access point, which operates in the 5 GHz-band, and a third access point, which operates in the 5 GHz-band, are attached to the same wireless base station, i.e., the wireless base station 2. In addition, assume that the number of available channels for those access points or the amount of channel bandwidth, decreases in the order of the third access point, the second access point, and the first access point. In such a case, the priority changing section 125 makes a priority of the third access point higher than priorities of the second and first access points. Further, the priority changing section 125 makes a priority of the second access point higher than the priority of the first access point. As a result, the portable terminal 1 can connect to the third access point, which allows the portable terminal 1 to obtain a higher throughput than any other access points.

### Embodiment 2

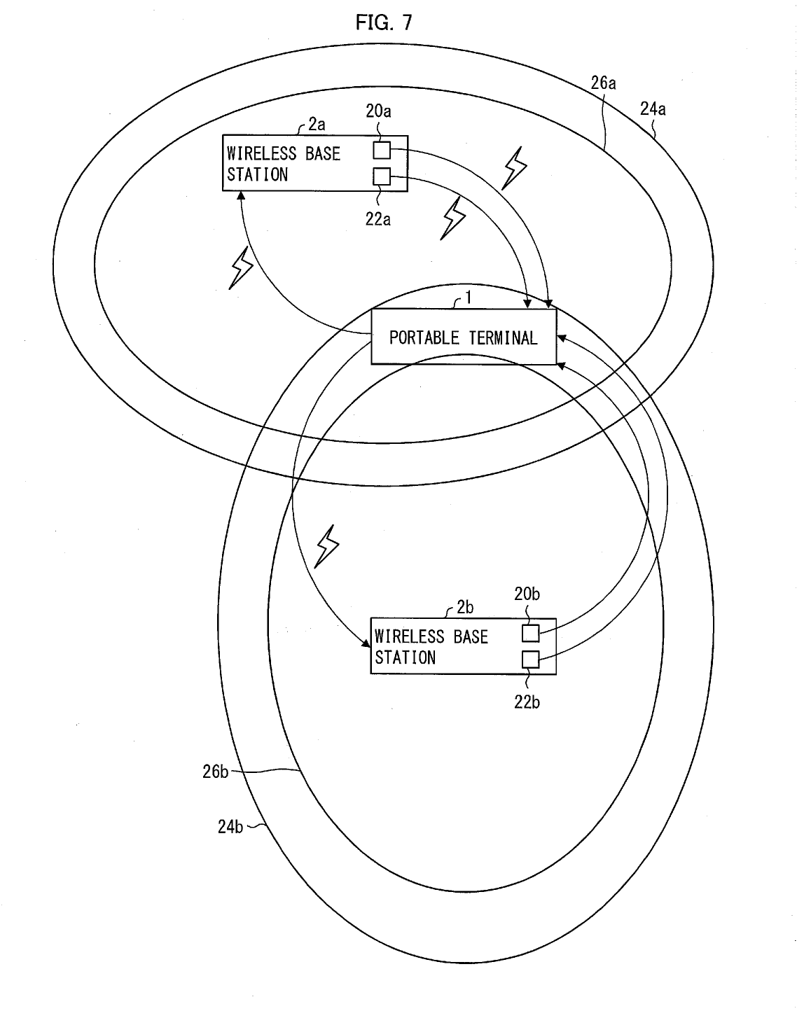

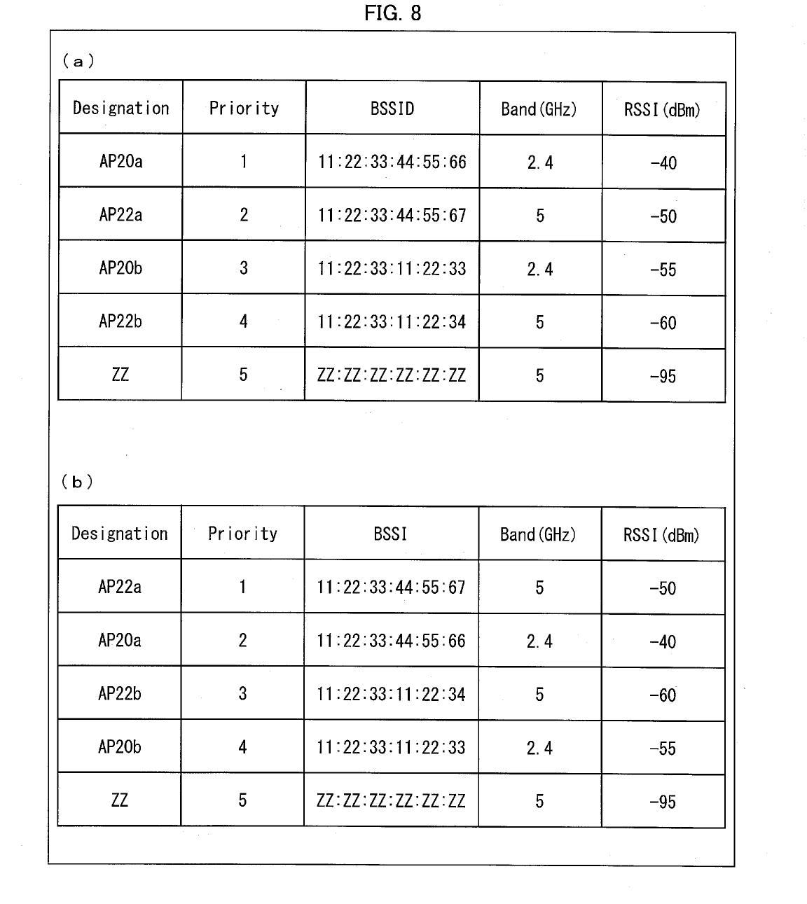

The following description will discuss a second embodiment in accordance with the present invention with reference to FIGS. 7 and 8. Note that members of the second embodiment that are identical to the members of the first embodiment are assigned equivalent symbols. Detailed explanations of such members will be omitted.

The configuration of a portable terminal 1 of the second embodiment is identical to the configuration of the portable terminal 1 of the first embodiment. However, the second embodiment is different from the first embodiment in the number of wireless base stations capable of performing wireless communications with the portable terminal 1.

(Wireless Base Stations 2a and 2b)

FIG. 7 is a diagram illustrating the portable terminal 1 in accordance with the second embodiment of the present invention and wireless base stations 2a and 2b each of which provides the portable terminal 1 with a public wireless LAN. As illustrated in FIG. 7, in the second embodiment, the portable terminal 1 is present at a position such that the portable terminal 1 can perform wireless communications with one of the two wireless base stations 2a and 2b.

In the example illustrated in FIG. 7, the wireless base station 2a, an access point 20a, an access point 22a, a cell 24a, and a cell 26b are equivalent to the wireless base station 2, the access point 20, the access point 22, the cell 24, and the cell 26 in accordance with the first embodiment. Therefore, detailed explanations of such members will be omitted.

The wireless base station 2b, like the wireless base station 2a, is a hub that relays connection of the portable terminal 1 to the Internet through wireless communications. In the second embodiment, the wireless base station 2b provides the portable terminal 1 with two types of public wireless LANs on which radio signals are transmitted in different frequency bands. The wireless base station 2b includes two different access points 20b and 22b. In other words, both the access points 20b and 22b are attached to the wireless base station 2b. The access point 20b supports 2.4 Hz band wireless communications. Meanwhile, the access point 22b supports 5 GHz band wireless communications.

As illustrated in FIG. 7, the wireless base station 2b covers two types of wireless communication cells 24b and 26b in which different frequency bands are used. The cell 24b corresponds to a 2.4 GHz band, while the cell 26b corresponds to a 5 GHz band. Due to their corresponding radio frequency characteristics, the cell 24b is larger than the cell 26b. As such, in an area within the cell 26b, the portable terminal 1 can connect to either the 2.4 GHz band access point 20b or the 5 GHz band access point 22b. Meanwhile, in an area falling outside the cell 26b and within the cell 24b, the portable terminal 1 can connect to the 2.4 GHz band access point 20b, but cannot connect to the 5 GHz band access point 22b.

The portable terminal 1 can access the Internet via the access point 20b or 22b. Communications between the portable terminal 1 and the access point 20b are wireless communications in the 2.4 GHz band. Meanwhile, communications between the portable terminal 1 and the access point 22b are wireless communications in the 5 GHz band.

The portable terminal 1 transmits a given scan request, which is a radio signal, for connecting to any of the public wireless LANs. In the second embodiment, both the wireless base station 2a and the wireless base station 2b receive the scan request. Then, both the wireless base station 2a and the wireless base station 2b transmit scan responses, which are responses to the scan request, to the portable terminal 1.

The access points 20a and 22a transmit their respective scan responses to the portable terminal 1. A scan response from the access point 20a includes various kinds of information on the access point 20a. Meanwhile, a scan response from the access point 22a includes various kinds of information on the access point 22a.

The access points 20b and 22b transmit their respective scan responses to the portable terminal 1. A scan response from the access point 20b includes various kinds of information on the access point 20b. Meanwhile, a scan response from the access point 22b includes various kinds of information on the access point 22b.

With use of the scan responses received from the wireless base stations 2a and 2b, a scan response processing section 12 of the portable terminal 1, generates pieces of access point information, for the individual access points capable of performing wireless communications, in a manner similar to the scan response processing section 12 of the first embodiment. Note that the portable terminal 1 is also capable of performing wireless communications with a third wireless base station (not illustrated), and the portable terminal 1 also receives a scan response from an access point that resides in the third wireless base station. As such, since the portable terminal 1 receives the scan responses from the five access points, the portable terminal 1 generates a total of five pieces of access point information.

A sorting section 121 sorts the pieces of access point information thus generated, according to RSSIs. In doing so, the sorting section 121 sets a given priority to each of the pieces of access point information according to the RSSIs. In the example illustrated in FIG. 7, the sorting section 121 sets Priority 1, which indicates the highest priority, to the access point 20a with the highest RSSI (−40 dBm). Further, the sorting section 121 sets Priority 2, which indicates the next highest priority, to the access point 22a with the next highest RSSI (−50 dBm). Still further, the sorting section 121 sets Priority 3, which indicates the further next highest priority, to the access point 20b with the further next highest RSSI (−55 dBm). Yet further, the sorting section 121 sets Priority 4, which indicates the still further next highest priority, to the access point 22b with the still further next highest RSSI (−60 dBm). Further, the sorting section 121 sets Priority 5 to the access point with the lowest RSSI (−95 dBm). The sorting section 121 associates the set priorities with the corresponding pieces of access point information. This completes the sorting of the pieces of access point information.

FIG. 8 is a diagram illustrating an example of pieces of access point information in accordance with the second embodiment of the present invention. (a) of FIG. 8 illustrates the pieces of access point information having been sorted. The scan response processing section 12 attempts change of the priorities set to the individual access points, in a manner similar to the scan response processing section 12 of the first embodiment.

The access points 20a and 22a are attached to the same wireless base station, i.e., the wireless base station 2a. In addition, the access point 20a operates in the 2.4 GHz band, while the access point 22 operates in the 5 GHz band. Besides, although not illustrated, the RSSI of the access point 22a exceeds a given threshold value. Accordingly, the priority changing section 125 makes the priority of the access point 22a higher than the priority of the access point 20a. As a result, the priority of the 5 GHz band access point 22a is increased from “2” to “1”, whereas the priority of the 2.4 GHz band access point 20a is decreased from “2” to “1”.

The access points 20b and 22b are attached to the same wireless base station, i.e., the wireless base station 2b. In addition, the access point 20b operates in the 2.4 GHz band, while the access point 22 operates in the 5 GHz band. Besides, although not illustrated, the RSSI of the access point 22b exceeds a given threshold value. Accordingly, the priority changing section 125 makes the priority of the access point 22b higher than the priority of the access point 20b. As a result, the priority of the 5 GHz band access point 22b is increased from “4” to “3”, whereas the priority of the 2.4 GHz band access point 20b is decreased from “3” to “4”.

(b) of FIG. 8 illustrates pieces of access point information that have undergone the priority change. The access point 22a has the highest priority after the priority change. Thus, the portable terminal 1, first, attempts wireless communication connection to the 5 GHz band access point 22a of the five access points.

(Advantages of the Second Embodiment)

Of the five access points to which the portable terminal 1 can perform wireless communication connection, the access points 22a and 22b operate in the 5 GHz band. Note that the access point not illustrated, which operates in the 5 GHz band but provides too low RSSI, will be outside the discussion below. As discussed earlier, before the determination is performed by the attaching base station determining section 122, the five generated pieces of access point information are originally sorted according to the RSSIs. As a result, the priority of the access point 22a, which is located closer to the portable terminal 1, is originally set higher than the priority of the access point 22b, which is located further from the portable terminal 1. Thus, even after the priority change, the priority of the access point 22a is kept higher than the priority of the access point 22b.

Accordingly, in a case where different access points all of which operate in the 5 GHz band, i.e., the access points 22a and 22b, are present, the portable terminal 1 first attempts wireless communication connection to the access point 22a, which is located closer to the portable terminal 1 than the other access point(s) which operates in the 5 GHz band. This avoids the portable terminal 1 from performing wireless communications through the access point 22b, which can lead to poor throughput even though it operates in the 5 GHz band. This allows the portable terminal 1 to perform faster and more stable wireless communications.

### Embodiment 3

The following description will discuss a third embodiment in accordance with the present invention with reference to the drawings. Note that members of the third embodiment that are identical to the members of the first and second embodiments are assigned equivalent symbols. Detailed explanations of such members will be omitted.

The configuration of a portable terminal 1 of the third embodiment is identical to the configuration of the portable terminal 1 of the first embodiment. However, the priority change permission requirement of the third embodiment is different from that of the first embodiment. Specifically, the priority change permission requirement of the third embodiment is such that (i) a 5 GHz band access point 22 and the portable terminal 1 support a specific bandwidth mode, and (ii) the RSSI of the access point 22 exceeds a given threshold value that is preset for that bandwidth mode.

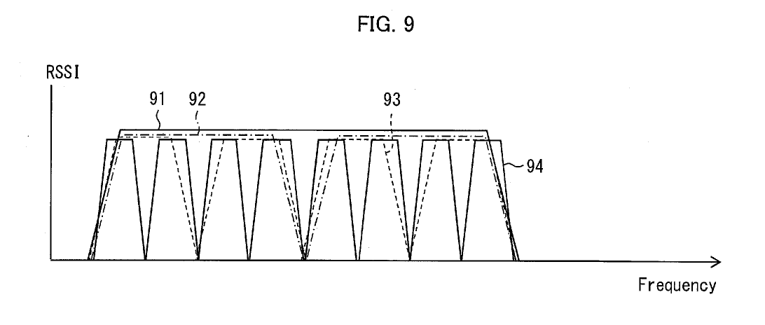

The following description will discuss an example of bandwidth modes with reference to FIG. 9. FIG. 9 is a diagram illustrating an example of bandwidth modes supported by the 5 GHz band access point 22 in accordance with the third embodiment of the present invention. In FIG. 9, RSSI is represented on a vertical axis, while a frequency is represented on a horizontal axis. In the third embodiment, the 5 GHz band access point 22 supports four different bandwidth modes corresponding to different bandwidths. Specifically, the four different bandwidth modes are HT160, HT80, HT40, and HT20, which are numbered 91, 92, 93, and 94 in FIG. 9, respectively. The portable terminal 1 also supports these four bandwidth modes.

Channel bandwidths in the modes HT160, HT80, HT40, and HT20 are 160 MHz, 80 MHz, 40 MHz, and 20 MHz, respectively. That is, the bandwidth decreases in the order of HT160, HT80, HT40, and HT20.

(Determination Concerning Priority Change Permission Requirement)

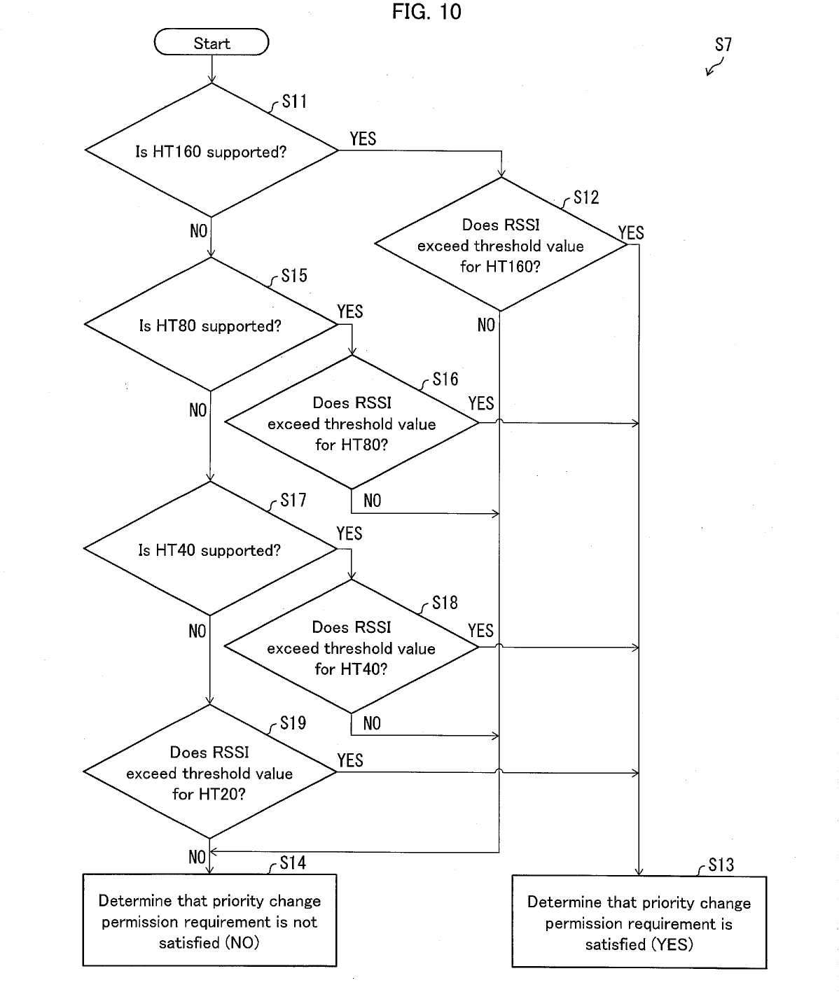

FIG. 10 is a flowchart illustrating a flow of a process in which a change determining section 124 in accordance with the third embodiment of the present invention determines whether to permit a priority change. In the third embodiment, in performing the process in step S7 of FIG. 3, the change determining section 124 performs a series of processes shown in FIG. 10.

First, the change determining section 124 determines whether the portable terminal 1 and the access point 22 support HT160 (step S11). If the result of the determination performed in step S11 is “true” (YES), the change determining section 124 determines whether the RSSI of the access point 22 exceeds a given threshold value that is set for HT160 (step S12). If the result of the determination performed in step S12 is “true” (YES), the change determining section 124 determines that the access point 22 satisfies the priority change permission requirement (step S13). On the other hand, if the result of the determination performed in step S12 is “false” (NO), the change determining section 124 determines that the access point 22 does not satisfy the priority change permission requirement (step S14).

Meanwhile, if the result of the determination performed in step S11 is “false” (NO), the change determining section 124 determines whether the portable terminal 1 and the access point 22 support HT80 (step S15). If the result of the determination performed in step S15 is “true” (YES), the change determining section 124 determines whether the RSSI of the access point 22 exceeds a given threshold value that is set for HT80 (step S16). If the result of the determination performed in step S16 is “true” (YES), the change determining section 124 determines that the access point 22 satisfies the priority change permission requirement (step S13). On the other hand, if the result of the determination performed in step S16 is “false” (NO), the change determining section 124 determines that the access point 22 does not satisfy the priority change permission requirement (step S14).

Meanwhile, if the result of the determination performed in step S15 is “false” (NO), the change determining section 124 determines whether the portable terminal 1 and the access point 22 support HT40 (step S17). If the result of the determination performed in step S17 is “true” (YES), the change determining section 124 determines whether the RSSI of the access point 22 exceeds a given threshold value that is set for HT40 (step S18). If the result of the determination performed in step S18 is “true” (YES), the change determining section 124 determines that the access point 22 satisfies the priority change permission requirement (step S13). On the other hand, if the result of the determination performed in step S18 is “false” (NO), the change determining section 124 determines that the access point 22 does not satisfy the priority change permission requirement (step S14).

Meanwhile, if the result of the determination performed in step S17 is “false” (NO), the portable terminal 1 and the access point 22 support HT20. Then, the change determining section 124 determines whether the RSSI of the access point 22 exceeds a given threshold value that is set for HT20 (step S19). If the result of the determination performed in step S19 is “true” (YES), the change determining section 124 determines that the access point 22 satisfies the priority change permission requirement (step S13). On the other hand, if the result of the determination performed in step S19 is “false” (NO), the change determining section 124 determines that the access point 22 does not satisfy the priority change permission requirement (step S14).

(Example of Comparison with Threshold Values)

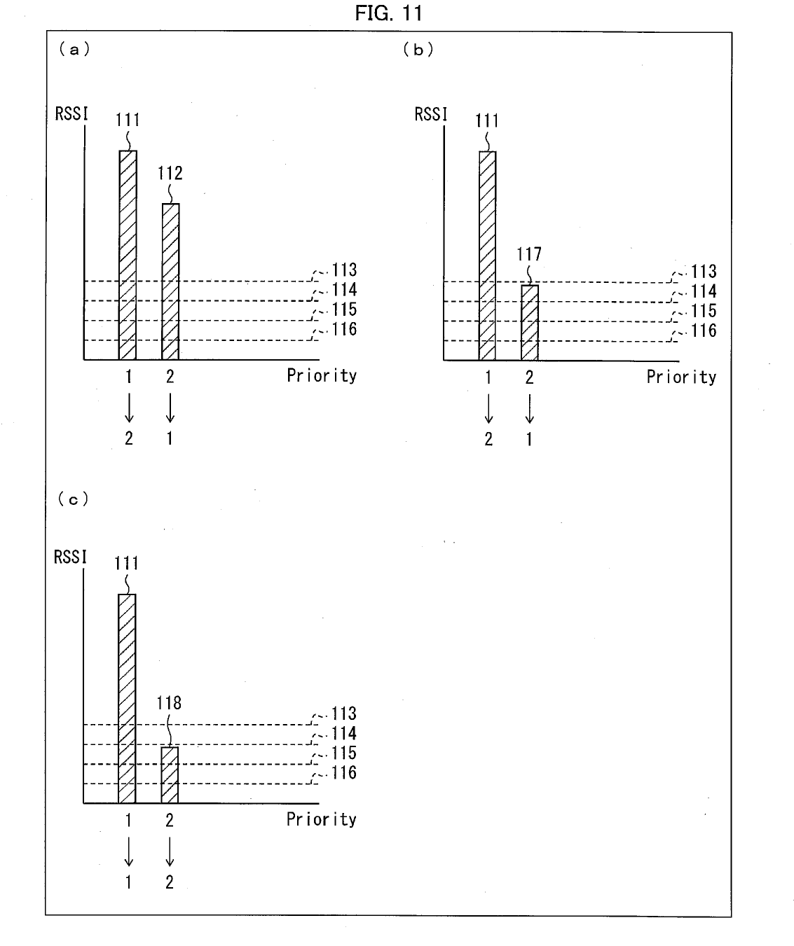

FIG. 11 is a diagram illustrating an example of given threshold values that are preset corresponding one-to-one to the individual bandwidth modes in the portable terminal 1 in accordance with the third embodiment of the present invention. In the example illustrated in FIG. 11, the portable terminal 1 presets a threshold value 113 corresponding to HT20, a threshold value 114 corresponding to HT40, a threshold value 115 corresponding to HT80, and a threshold value 116 corresponding to HT160. The broader the bandwidth in the corresponding mode is, the lower the threshold value is.

In the example illustrated in FIG. 11, “111” represents RSSI calculated based on the scan response from the access point 20 (2.4 GHz band). Further, “112” represents RSSI calculated based on the scan response from the access point 22 (5 GHz band). The example illustrated in FIG. 11 assumes that the portable terminal 1 and the access point 22 support HT40.

In (a) of FIG. 11, the RSSI 112 of the access point 22 exceeds the threshold value 113 for HT20, which is the highest of the four threshold values. That is, the RSSI 112 also exceeds the threshold value 114 for HT40. As such, the change determining section 124 determines that the access point 22 satisfies the priority change permission requirement. As a result, the priority changing section 125 inverts a priority of the access point 20 and a priority of the access point 22.

In (b) of FIG. 11, the RSSI 117 of the access point 22 is below the threshold value 113 for HT20, but exceeds the threshold value 114 for HT40. As such, the change determining section 124 determines that the access point 22 satisfies the priority change permission requirement. As a result, the priority changing section 125 inverts the priority of the access point 20 and the priority of the access point 22.

In (c) of FIG. 11, the RSSI 118 of the access point 22 is below the threshold value 114 for HT40. As such, the change determining section 124 determines that the access point 22 is an abnormal one and thus does not satisfy the priority change permission requirement. As a result, the priority changing section 125 does not invert the priority of the access point 20 and the priority of the access point 22.

(Advantages of the Third Embodiment)

As described above, the third embodiment presets appropriate threshold values corresponding one-to-one to the individual bandwidth modes supported by the 5 GHz band access point 22. This makes it possible to appropriately and flexibly determine whether to invert the priorities according to the bandwidth modes supported by the access point 22.

### Embodiment 4

The following description will discuss a fourth embodiment in accordance with the present invention with reference to the drawings. Note that members of the fourth embodiment that are identical to the members of the first to third embodiments are assigned equivalent symbols. Detailed explanations of such members will be omitted.

The configuration of a portable terminal 1 of the fourth embodiment is identical to the configuration of the portable terminal 1 of the second embodiment. Further, the portable terminal 1, like the portable terminal 1 of the second embodiment, is present at a position such that the portable terminal 1 can perform wireless communications with wireless base stations 2a and 2b. However, the priority change permission requirement of the fourth embodiment is different from that of the second embodiment. Specifically, the priority change permission requirement in accordance with the fourth embodiment is such that both of the following first and second conditions are satisfied. The first condition is such that, among the 2.4 GHz band access point and the 5 GHz band access point both of which are attached to the same wireless base station, the 5 GHz band access point supports a given bandwidth mode (specifically, HT80) corresponding to a relatively large bandwidth, and the portable terminal 1 also supports the same bandwidth mode (i.e., HT80). The second condition is such that the RSSI of the 5 GHz band access point exceeds a given threshold value that is set for that bandwidth mode.

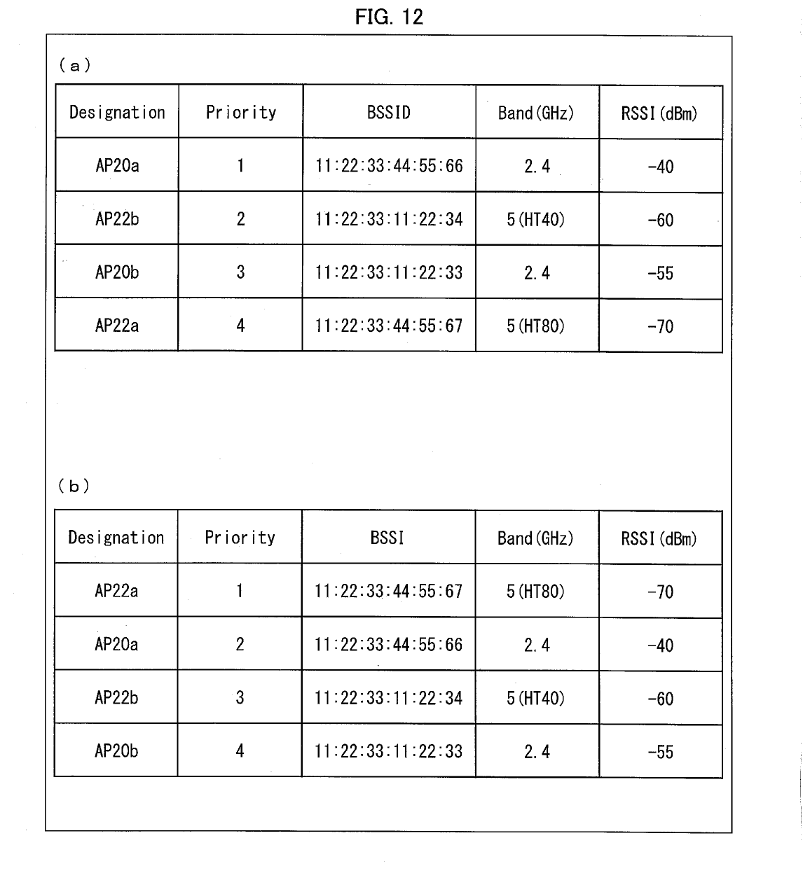

FIG. 12 is a diagram illustrating an example of pieces of access point information in accordance with the fourth embodiment of the present invention. (a) of FIG. 12 illustrates four pieces of access point information having been generated by a scan response processing section 12 and then sorted by a sorting section 121. As illustrated in FIG. 12, the 5 GHz band access point 22a supports HT80. Further, although not illustrated in FIG. 12, the RSSI of the 5 GHz band access point 22a exceeds a given threshold value that is set corresponding to HT80. Thus, the change determining section 124 determines, in step S7 of FIG. 3, that the access points 20a and 22a satisfy the priority change permission requirement. Accordingly, the priority changing section 125 makes the priority of the access point 22a higher than the priority of the access point 20a. As a result, the priority of the access point 22a is increased from “4” to “1”.

The priority changing section 125 decrements the current priority levels of the other access points by one. As a result, the priority of the access point 20a is decreased from “1” to “2”. (b) of FIG. 12 illustrates the pieces of access point information having been subjected to the priority change.

(Advantages of the Fourth Embodiment)

In a case where the 5 GHz band access point 22a supports HT80, and the RSSI of the 5 GHz band access point 22a exceeds the threshold value set for HT80, the portable terminal 1 makes the priority of the access point 22a higher than the priority of the access point 20a. This allows the portable terminal 1 to perform 5 GHz band wireless communications using HT80, which corresponds to a relatively large bandwidth, with the wireless base station 2.

Note that the given bandwidth mode is not limited to HT80. Alternatively, the given bandwidth may be, for example, HT40 or HT160.

[Software Implementation Example]

Control blocks of the portable terminal 1 (particularly, the scan response processing section 12 and the connection processing section 14) can be realized by a logic circuit (hardware) provided in an integrated circuit (IC chip) or the like or can be alternatively realized by software as executed by a central processing unit (CPU).

In the latter case, the portable terminal 1 includes: a CPU that executes instructions of a program that is software realizing the foregoing functions; ROM (Read Only Memory) or a storage device (each referred to as “storage medium”) storing the program and various kinds of data in such a form that they are readable by a computer (or a CPU); and RAM (Random Access Memory) that develops the program in executable form. The object of the present invention can be achieved by a computer (or a CPU) reading and executing the program stored in the storage medium.

The storage medium may be “a non-transitory tangible medium” such as a tape, a disk, a card, a semiconductor memory, and a programmable logic circuit. Further, the program may be supplied to or made available to the computer via any transmission medium (such as a communication network and a broadcast wave) which enables transmission of the program. Note that the present invention can also be implemented by the program in the form of a computer data signal embedded in a carrier wave which is embodied by electronic transmission.

[Recap]

A portable terminal in accordance with a first aspect of the present invention includes: a determining section (attaching base station determining section 122) that determines whether two different access points capable of wireless communications with the portable terminal are attached to the same wireless base station; a setting section (priority changing section 125) that sets, to a first access point (access point 22) that is one of the plurality of access points having been determined to be attached to the same wireless base station, a priority higher than a priority of the other access point (access point 20), the first access point providing (i) the largest number of available channels and/or (ii) the largest amount of channel bandwidth among all the plurality of access points having been determined to be attached to the same wireless base station; and a connecting section (connection processing section 14) that attempts wireless communication connections to the access points in descending order of the priorities set by the setting section.

According to the above arrangement, in a case where the plurality of access points are attached to the same wireless base station, the portable terminal connects preferentially to a certain access point that is one of the plurality of access points, wherein the certain access point provides (i) the largest number of available channels and/or (ii) the largest amount of channel bandwidth among all the plurality of access points having been determined to be attached to the same wireless base station. This yields the effect of allowing the portable terminal to perform faster and more stable wireless communications with the access point.

In a second aspect of the present invention, a portable terminal is preferably arranged such that, in the first aspect of the present invention, the determining section determines that the two access points are attached to the same wireless base station in a case where the pieces of identification information of the plurality of access points are similar to each other.

According to the above arrangement, it is possible to easily determine whether two access points are attached to the same wireless base station.

In a third aspect of the present invention, a portable terminal is preferably arranged such that, in the second aspect of the present invention, the pieces of identification information are BSSIDs.

In a fourth aspect of the present invention, a portable terminal is preferably arranged such that, in the third aspect of the present invention, the determining section determines that the respective BSSIDs of the plurality of access points are similar to each other in a case where the respective BSSIDs of the plurality of access points are such that values of a predetermined number of bits at their corresponding positions in the BSSIDs are identical to each other.

According to the above arrangement, it is possible to reliably determine whether the BSSIDs of the two access points are similar to each other.

In a fifth aspect of the present invention, a portable terminal is preferably arranged such that, in the first to fourth aspects of the present invention, the setting section sets, to the first access point, a priority higher than a previously set priority in a case where a signal strength value of a radio signal transmitted from the first access point exceeds a given threshold value.

According to the above arrangement, the portable terminal connects preferentially to the first access point in a case where the first access point provides high performance. This yields the effect of securing excellent wireless communications between the portable terminal and the first access point.

In a sixth aspect of the present invention, a portable terminal is preferably arranged such that, in the first to fifth aspects of the present invention, before the determination performed by the determining section, the setting section originally sets the priorities to the individual access points so that a higher priority is set to any one of the access points which transmits a radio signal with a higher signal strength value.

According to the above arrangement, a higher priority is set to an access point that is present closer to the portable terminal, before the determination performed by the determining section. With this arrangement, in a case where a plurality of different wireless base stations to which respective first access points are attached are present around the portable terminal, it is possible to prevent the portable terminal from connecting to the first access point that is present further from the portable terminal.

In a seventh aspect of the present invention, a portable terminal is preferably arranged such that, in the first to sixth aspects of the present invention, the setting section sets, to the first access point, a priority higher than a previously set priority in a case where both the portable terminal and the first access point support a given bandwidth mode, and a signal strength value of a radio signal transmitted from the first access point exceeds a given threshold value that is set for that bandwidth mode.

The above arrangement allows the portable terminal to perform stable wireless communications with the access point in a given bandwidth mode supported by the portable terminal.

In an eighth aspect of the present invention, a portable terminal is preferably arranged such that, in the first to sixth aspects of the present invention, the setting section sets, to the first access point, a priority higher than a previously set priority in a case where both the portable terminal and the first access point support a given bandwidth mode.

The above arrangement allows the portable terminal to perform wireless communications with the access point in a given bandwidth mode.

Note that the given bandwidth mode is preferably HT80.

The above arrangement allows the portable terminal to perform high-speed wireless communications with the access point in HT80.

Note that the first access point is a 5 GHz band access point, while the second access point is a 2.4 GHz band access point.

The above arrangement allows the portable terminal to connect preferentially to the 5 GHz band access point through which higher throughput is obtained.

A method for controlling a portable terminal in accordance with a ninth aspect of the present invention includes: a determining step of determining whether a plurality of different access points capable of wireless communications with the portable terminal are attached to the same wireless base station; a setting step of setting, to a first access point that is one of the plurality of access points having been determined to be attached to the same wireless base station, a priority higher than a priority of the other access point, the first access point providing (i) the largest number of available channels and/or (ii) the largest amount of channel bandwidth among all the plurality of access points having been determined to be attached to the same wireless base station; and a connecting step of attempting wireless communication connections to the access points in descending order of the priorities set in the setting step.

The above arrangement yields the same effect as the effect yielded by the portable terminal in accordance with the present invention.

The portable terminal according to the foregoing embodiments of the present invention may be realized by a computer. In this case, the present invention encompasses: a program for the portable terminal which program causes a computer to operate as the foregoing sections of the portable terminal so that the portable terminal can be realized by the computer; and a computer-readable storage medium storing the program therein.

The present invention is not limited to the embodiments, but can be altered by a skilled person in the art within the scope of the claims. An embodiment derived from a proper combination of technical means each disclosed in a different embodiment is also encompassed in the technical scope of the present invention. Further, it is possible to form a new technical feature by combining the technical means disclosed in the respective embodiments.

### INDUSTRIAL APPLICABILITY

The present invention is applicable to various portable terminals, including a portable telephone, a smartphone, and a tablet terminal, that perform wireless communications with access points.

### REFERENCE SIGNS LIST

1 Portable terminal
2 Wireless base station
10 Scan request transmitting section
12 Scan response processing section (determining section, setting section)
14 Connection processing section (connecting section)
20 Access point (other access point)
22 Access point (first access point)
24 Cell
26 Cell
121 Sorting section
122 Attaching base station determining section (determining section)
123 Band determining section
124 Change determining section
125 Priority changing section (setting section)
126 Connection destination notifying section

1: A portable terminal comprising:
a determining section that determines whether a plurality of different access points capable of wireless communications with the portable terminal are attached to the same wireless base station;
a setting section that sets, to a first access point that is one of the plurality of access points having been determined to be attached to the same wireless base station, a priority higher than a priority of the other access point, the first access point providing (i) the largest number of available channels and/or (ii) the largest amount of channel bandwidth among all the plurality of access points having been determined to be attached to the same wireless base station; and
a connecting section that attempts wireless communication connections to the access points in descending order of the priorities set by the setting section.

2: The portable terminal according to claim 1, wherein the determining section determines that the plurality of access points are attached to the same wireless base station in a case where the pieces of identification information of the plurality of access points are similar to each other.

3: The portable terminal according to claim 2, wherein the pieces of identification information are BSSIDs.

4: The portable terminal according to claim 3, wherein the determining section determines that the respective BSSIDs of the plurality of access points are similar to each other in a case where the respective BSSIDs of the plurality of access points are such that values of a predetermined number of bits at their corresponding positions in the BSSIDs are identical to each other.

5: The portable terminal according to claim 1, wherein the setting section sets, to the first access point, a priority higher than a previously set priority in a case where a signal strength value of a radio signal transmitted from the first access point exceeds a given threshold value.

6: The portable terminal according to claim 1, wherein before the determination performed by the determining section, the setting section originally sets the priorities to the individual access points so that a higher priority is set to any one of the access points which transmits a radio signal with a higher signal strength value.

7: The portable terminal according to claim 1, wherein the setting section sets, to the first access point, a priority higher than a previously set priority in a case where both the portable terminal and the first access point support a given bandwidth mode, and a signal strength value of a radio signal transmitted from the first access point exceeds a given threshold value that is set for that bandwidth mode.

8: The portable terminal according to claim 1, wherein the setting section sets, to the first access point, a priority higher than a previously set priority in a case where both the portable terminal and the first access point support a given bandwidth mode.

9: A method for controlling a portable terminal, comprising:
a determining step of determining whether a plurality of different access points capable of wireless communications with the portable terminal are attached to the same wireless base station;
a setting step of setting, to a first access point that is one of the plurality of access points having been determined to be attached to the same wireless base station, a priority higher than a priority of the other access point, the first access point providing (i) the largest number of available channels and/or (ii) the largest amount of channel bandwidth among all the plurality of access points having been determined to be attached to the same wireless base station; and
a connecting step of attempting wireless communication connections to the access points in descending order of the priorities set in the setting step.
